(19) United States
(12) Patent Application Publication
(10) Pub. No.: US 2013/0324159 A1
(43) Pub. Date: Dec. 5, 2013

(54) System And Method To Dynamically Update Content Based On Location Information

(71) Applicants: Geoffrey Smalling, San Anselmo, CA (US); William Clifford, San Francisco, CA (US)

(72) Inventors: Geoffrey Smalling, San Anselmo, CA (US); William Clifford, San Francisco, CA (US)

(73) Assignee: Wine.com, Inc., San Francisco, CA (US)

(21) Appl. No.: 13/484,256

(22) Filed: May 30, 2012

(51) Int. Cl. H04W 24/00

(52) U.S. Cl. 455/456.3

(57) ABSTRACT

A system for dynamically updating website content is described. The system includes memory, one or more processors and one or more modules stored in memory and configured for execution by the one or more processors. The modules include a location detection module configured to determine location information of a user device. The modules also include a transmission module configured to transmit the location information of the user device to a server. The modules include a reception module configured to receive content information based on the received location information from the server. In addition, the modules include a display module to transform the content information into a format to view on the user device.

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever

### FIELD

Embodiments of the invention relate to system for dynamically updating content. In particular, embodiments of the invention relate to a system that updates based on location information.

### BACKGROUND

An online shopping system provides the shopper the benefit of shopping for merchandise from any location. This provides the ability of a shopper to find the merchandise the shopper is looking for at any time. The online shopping site typically includes all the merchandize the seller had available listed on the online shopping site such as a webpage. The seller usually only needs to determine the location information of the shopper after the shopper buys one or more items for the purpose of shipping.

However, some merchandise is regulated by states or even one or more jurisdictions within a state. Another problem includes an online shopping site that has merchandize that may be too costly to ship to certain locations. As such, the online shopping system has a need to know the location of a shopper before the shipping information is provided by a user, current systems do not have this capability.

### SUMMARY

A system for dynamically updating website content is described. The system includes memory, one or more processors and one or more modules stored in memory and configured for execution by the one or more processors. The modules include a location detection module configured to determine location information of a user device. The modules also include a transmission module configured to transmit the location information of the user device to a server. The modules include a reception module configured to receive content information based on the received location information from the server. In addition, the modules include a display module to transform the content information into a format to view on the user device.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of an embodiment of a system on a user device;

FIG. 2 illustrates a block diagram of a distributed system according to an embodiment;

FIG. 3 illustrates a flow diagram for updating content information according to an embodiment;

FIG. 4 illustrates a document that formed from content information based on location information;

FIG. 5 illustrates a document formed from content information determined in part on business rules;

FIG. 6 illustrates a document formed from content information determined in part on regulations;

FIG. 7 illustrates a block diagram of a system according to an embodiment; and

FIG. 8 illustrates a block diagram of a user device according to an embodiment.

### DETAILED DESCRIPTION

Embodiments of a system to update a mobile website based on geolocation information are described. Specifically, embodiments of a system configured to retrieve geolocation information from a user device requesting to view a mobile website. Based on the geolocation information the system determines a set of rules for applying to content information for the website. The system generates content information based on the received geolocation information. The content information is then displayed as a website for a user to browse for selecting merchandise to purchase.

An embodiment of a system includes an online shopping system that sells merchandise that is regulated. For example, such a system may sell alcohol products including, but not limited to, wine, spirits, and beer. Because of regulations, certain products, such as alcohol products, cannot be sold in all locations or under certain conditions. As such, an embodiment of an online shopping system uses location information, such as geolocation information, to dynamically update content information on a webpage to show products available to a user for that user's location or a shipping location.

According to an embodiment, the content information is selected based on rules to ensure compliance with regulations and business rules that benefit the seller. For some merchandise, local laws or regulations may regulate the sale of merchandise in a specific location, for example, regulations may require merchandise to be shipped from certain locations or may be required to be sold at a particular price. For some locations, the sale of wine or other alcoholic beverages is regulated at the state and even county level. Embodiments of the system may tailor content information of a website to display relevant merchandise, prices, or availability based on the location information of a user. Such a manner of dynamically updating content information based on location information streamlines a user's experience and prevents a shopper or user from moving forward with a purchase based on merchandise that is not appropriate for the user's location.

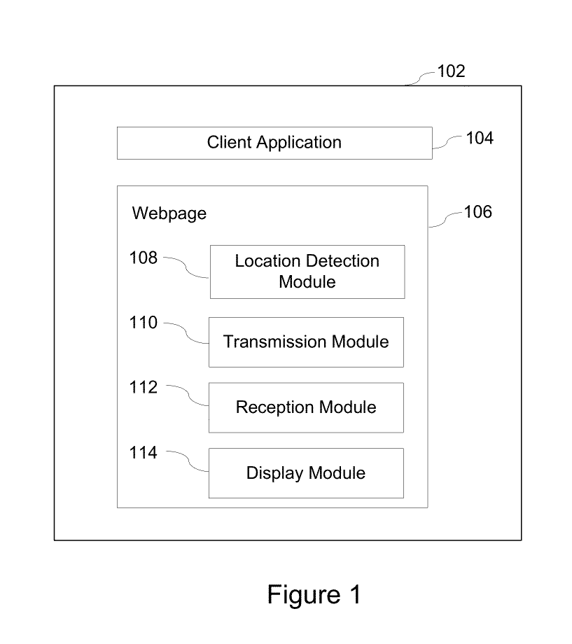

FIG. 1 illustrates a block diagram of a distributed system to dynamically update a document including, but not limited, to a webpage, remotely located document, dynamically generated document, or other document including information, based on location information including, but not limited to, geolocation information, one or more user preferences based on account information, one or more user preferences based on past history, an address, a merchandise destination location, or other information. According to an embodiment, user device 102 may be any device for viewing a document that includes information including, but not limited to, a mobile phone, a computer, a tablet computer, a personal digital assistant (PDA) or other mobile device. User device 102, according to an embodiment, includes one or more client application 102 that may be used to communicate through a network. For some embodiments, a client application 104 may be an application for viewing, searching, or using resources over a communication network. According to some embodiments, a client application 104 includes a web browser for retrieving and viewing a document, such as one or more webpages 106, application, script or executable file for retrieving information from a remote source and providing information to a user device 102.

According to an embodiment, a client application 104 retrieves a webpage 106 using address information including, but not limited to, a domain name, an internet protocol address (“IP address”), a media access control (“MAC”) address, or a uniform resource locator (“URL”). For example, client application 104 retrieves a webpage 106 from an online shopping system. As illustrated in FIG. 1, the retrieved or accessed webpage 106 may include a location detection module 108. For an embodiment, a location detection module 108 determines location information of a user device 102. Location information may include, but is not limited to, information obtained based on an IP address, a MAC address, a wireless connection, or a global positioning system. According to an embodiment location detection module 108 includes a client-side script embedded in the webpage 106. The script may be written or coded using Perl, PHP, ASP.NET, Java, VBScript, or any other scripting language. For another embodiment, a webpage 106 may include a reference to an external program or script that determines the location information of the user device 102. For a specific embodiment, a location detection module 108 is a function in a markup language used to create a webpage 106 such as an HTML 5 function. According to an embodiment, a location detection module 108 may use a HTML 5 geolocation property on a user device 102 to determine location information. An embodiment includes using a JavaScript call, such as a navigator.geolocation.getCurrentPosition( ) call to determine location information of a user device 102.

According to an embodiment, a location detection module 108 determines location information of a user device 102 by referencing location information maintained by the user device 102. For some embodiments, a user device 102 provides latitude and longitude information obtained from a global positioning system to a location detection module 108. As illustrated in FIG. 1, the embodiment may also include a transmission module 110. For an embodiment, a transmission module 110 is configured to transmit the location information from a user device 102. A transmission module 110, according to embodiments, may be a script, program, or function associated with a webpage 106 using techniques similar to those discussed with regard to embodiments of the location detection module 108. According to an embodiment, a transmission module 110 transmits the location information through a communication network back to the online shopping system. According to an embodiment, a transmission module 110 transforms the location information into a format for the online shopping system.

A reception module 112, according to an embodiment, is configured to receive content information based on the location information transmitted by a transmission module 110. According to an embodiment, a reception module 112 may be a script, program, or function associated with a webpage 106 using techniques similar to those discussed with regard to an embodiment of a location detection module 108. Such content information may include a catalogue of merchandise based on the location information received from a transmission module 110.

The embodiment illustrated in FIG. 1 also includes a display module 114. According to an embodiment, a display module 114 may be a script, program, or function associated with a webpage 106 using techniques similar to those discussed with regard to an embodiment of a location detection module 108. According to some embodiments, a display module 114 may also include markup language, cascading style sheets (“CSS”), or templates used by a client application 104, such as a browser to transform or render the content information in a format for viewing on a user device 102.

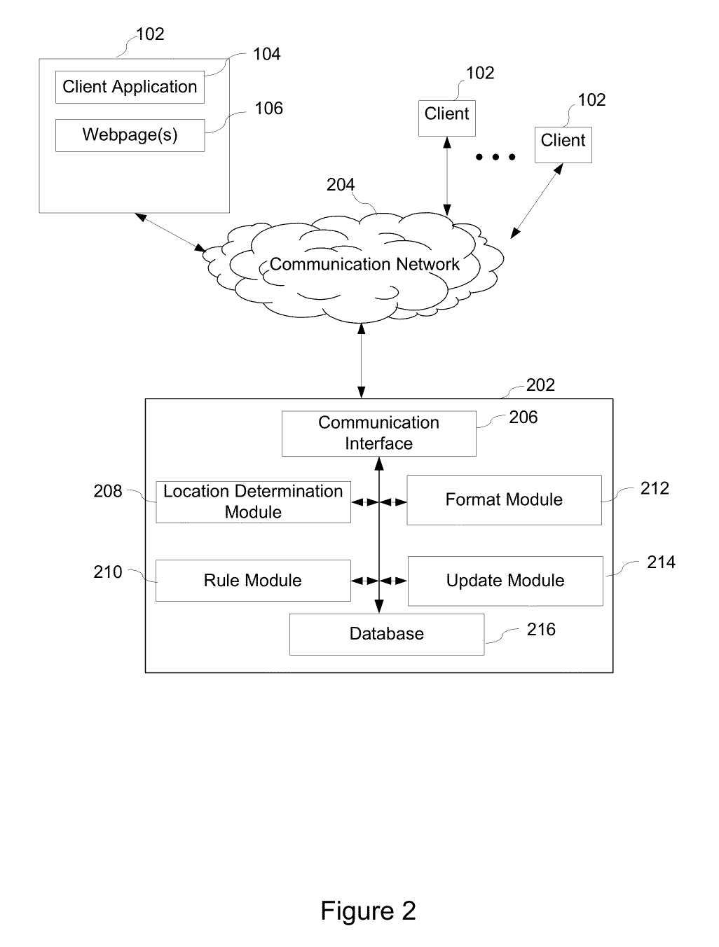

FIG. 2 illustrates a distributed system including a user device 102 coupled with a system 202 including, but not limited to, an online shopping system, a retail system, a product information system, or other system for providing information. According to an embodiment, a user device 102 is coupled with a system 202 through a communication network 204. A communication network 204 includes, but is not limited to, a wide area network (“WAN”), such as the Internet, a local area network (“LAN”), a wireless network, or other type of network. According to embodiments, one or more user device 102 may be communication with a system 202 through a communication network 204.

A system 202, according to an embodiment, includes a communication interface 206 configured to communicate with one or more user devices 102 or other clients through a communication network 204 using communication protocols. For some embodiments a communication interface 206 manages communications sessions between a system 202 and one or more user devices 102. A communication interface 206 may also convert or package data or content information into the appropriate communication protocol depending on a protocol used by a user device 102. According to some embodiments, a communication interface 206 may be configured to use one or more communications protocols for one or more communication layers, such communication protocols include, but are not limited to, hypertext transfer protocol (“HTTP”), transmission control protocol (“TCP”), Internet Protocol (“IP”), user datagram protocol (“UDP”), file transfer protocol (“FTP”), or any other communication protocol.

A system 202, according to an embodiment, includes a location determination module 208 that is coupled with a communication interface 206. A location determination module 208, according to an embodiment, is configured to receive location information from a user device 102. A location determination module 208 is configured to determine geolocation information of a user device 102 based on the location information received. For an embodiment, geolocation information includes one of or any combination of a state, a city, a county, a zip code, a street address, a street number, a building name, a country, a postal code, or other physical address information. According to an embodiment, a location determination module 208 receives latitude and longitude information from a user device 102.

For some embodiments, a location determination module 208 accesses an external system or database such as, a location information server, to acquire geolocation information. For some embodiments, a location determination module 208 includes an application programming interface (“API”) to interface with one or more location information server to request geolocation information based on the location information received from a user device 102. Such a location information server includes Google's network location server, SimpleGeo or other service hosting a location information server. Other embodiments include a system including a location information server. According to an embodiment, a location determination module 208 may be configured to receive one or more types of location information including, but not limited to, information obtained based on an IP address, a MAC address, a wireless connection, a wifi node, a cell phone data, or a global positioning system for determining the geolocation information of a user device 102.

FIG. 2 illustrates an embodiment that also includes a rule module 210 coupled with a geolocation determine module 208. A rule module 210, according to an embodiment, is configured to determine one or more rules to apply to content information for a user device 102. According to an embodiment, a rule module 210 is configured to receive geolocation information from a location determination module 208. A rule module 210 references a database 216 or lookup table, according to an embodiment, that includes rules. According to some embodiments a database 216 or lookup table may include a reference or a value that corresponds to one or more rules based on geolocation information. For some embodiments, a reference or a value includes a pointer or address location of a catalog of content information that is tailored to or complies with rules for a given geolocation information. For an embodiment, a database 216 or lookup table may be a one or more memories or one or more servers within a system 202 or separate from a system 202. According to other embodiments, a rule module 210 may access more than one database 216 or lookup table. Yet another embodiment includes rule module 210 accessing a database that includes catalogs of content information preconfigured for one or more geolocation information.

A rule module 210, according to an embodiment, may be configured to take into account federal regulations, state regulations, county regulations, business rules, regional preferences or other criteria for selecting merchandise to display based on geolocation information. For some embodiments, a rule module 210 is configured to include state and/or county alcohol regulations including, but not limited to, price requirements, shipping requirements, quantity requirements, alcohol content requirements, and other requirements related to selling and distributing alcohol. According to an embodiment, a rule module 210 is configured to include one or more business rules including, but not limited to, one or more of a preferred shipping location, a preferred shipping option, a preferred warehouse, a preferred warehouse state, a preferred merchandise origin location, a price, a profit margin, a gross margin, a minimum quantity, a cost of shipping, a shipping rule based on a merchandise origin location, a shipping rule based on a merchandise destination location, a user preference, or a user history, or other factors related to a business.

According to an embodiment as illustrated in FIG. 2, online shopping system 202 includes an update module 214. According to an embodiment, an update module 214 is coupled with a rule module 210 and is configured to receive rule information from a rule module 210. According to some embodiments, rule information may include, but is not limited to, a variable, a pointer, an address, a reference, a function call or other information that corresponds to one or more rules to apply. Based on the received rule information from a rule module 210, an update module 214 determines the content information. According to an embodiment, update module 214 performs a search of a database of merchandise that corresponds to the rule information to create a set of merchandise or other content information. For another embodiment, a plurality of sets or catalogs of items, merchandise, or other information may be preselected and each of the sets or catalogs may be associated with rule information from a rule module 210. Such an embodiment would access the set or catalog of merchandise, for example by retrieving the catalog of merchandise from a memory, a database 216, or an external server, to form content information. For some embodiments, an update module 214 excludes merchandise from a catalog based on rule information received from a rule module 210 to form content information.

A system 202, according to the embodiment illustrated in FIG. 2, includes a format module 212 coupled with an update module 214. According to an embodiment, a format module 212 is configured to receive content information from an update module 214 and transform content information into a format for a user device 102. For one example, a format module 212 may transform content from a database format into a markup language format for viewing on a client application 104, such as a web browser, on a user device 102. For an embodiment, a format module 212 converts content information received from update module 214 into a compatible version of HyperText Markup language (“HTML”) or Extensible HyperText Markup Language (“XHTML”) for a client application 104. According to some embodiments, a format module 212 is configured to append content information received from an update module 214 with cascading style sheets, scripts, or other format information to instruct a client application how to display or format the received content information. A format module 212, according to an embodiment, may determine changes in content information received from an update module 214 based one or more sets of content information previously transmitted to a user device 102. As such, a format module 212 may prepare the updated or changed content information from the previously sent content information into a format for a client application 104. According to an embodiment, a format module 212 determines any changes in content information from a set previously sent to a user device 102 based on a cookie, token, log, or other record of content information transmitted to a user device 102. The formatted content information, according to an embodiment, is then transmitted to a communication interface 206 for transmission to one or more clients 102. Thus, according to an embodiment, a user device 102 would receive content information for viewing on a webpage based on the location of a user device.

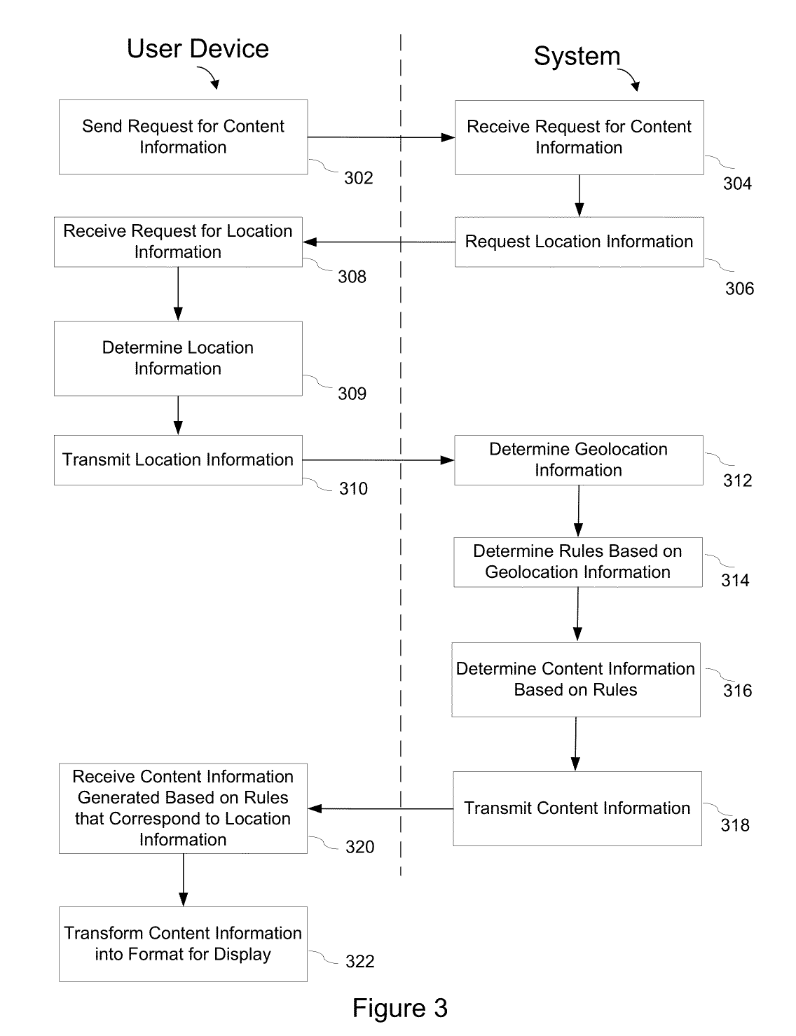

FIG. 3 illustrates a flow diagram for updating content information according to an embodiment. At block 302, a user device sends a request to access a document or content information on a system 102. Such a request includes navigating to a URL to view a webpage, accessing an FTP site, or otherwise accessing a resource on a remote system. As discussed above the request may be generated by a client application 102 responsive to user input, for example entering a URL. A system 202 receives the request at block 304 and transmits a request for location information from a user device 102 at block 306. According to an embodiment, the request for location information is transmitted with information for generating a document on a user device, such as HTML, XHTML, pictures and/or other instructions that instruct a client application to generate a document for viewing on a user device.

A user device 102 receives the request at block 308 and at block 309 determines location information that relates to the location of the user device according to techniques discussed above. A user device, at block 310, transmits the location information to a system 202. A user device 102, according to an embodiment, may transform the location information before transmitting using techniques described herein. A system 202 uses location information received from a user device 102 to determine geolocation information at block 312 using one or more of the techniques discussed herein. At block 314, a system 202 determines a set of rules based on a determined geolocation information as discussed herein. A system 202, at block 316, determines content information based on the determined rules as discussed herein. A system 202, according to an embodiment, optionally formats and transmits the determined content information to a user device 102 at block 318 using techniques described herein. The determined content information is received by a user device 102 at block 320 and, according to some embodiments, the user device 102 transforms the content information into a format for a user interface at block 322. For an embodiment, content information may be transformed by a client application such as a web browser or other application for display.

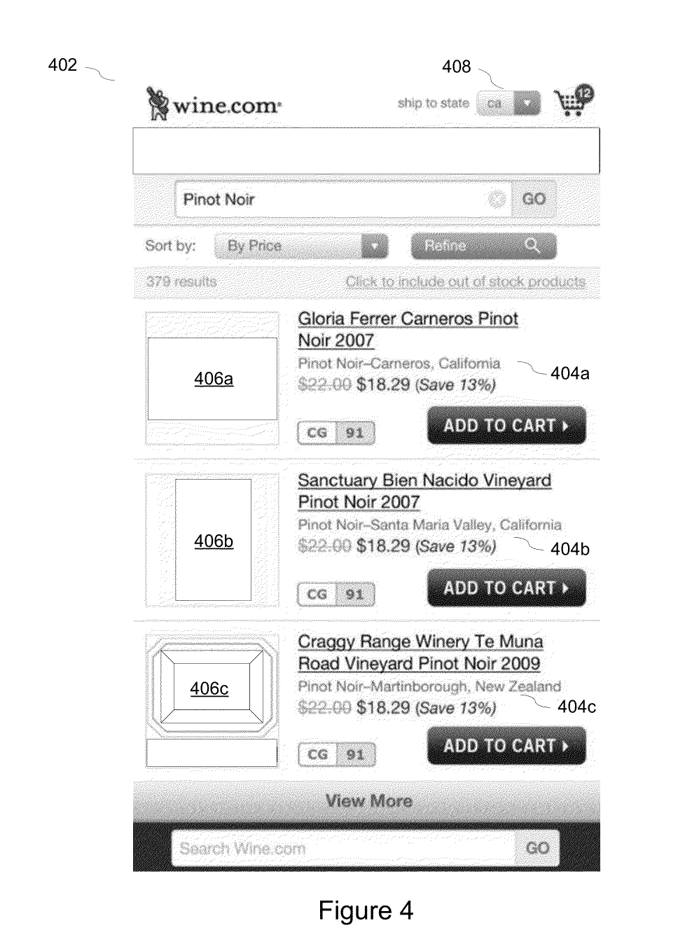

FIG. 4 illustrates a document 402, such as a webpage or page of an application to display information, formed from content information received by a user device generated based on rules. A document 402, according to an embodiment, includes content information such as product information 404a-b that can be sold in the location determined using techniques discussed above. According to some embodiments, some or all of the product information may be generated based on the determined geolocation information received from a user device. Product information may include, but is not limited to, product name, price, list price, discount, rating information, or other information. One or more of the information included may be generated for a user device based on the determined geolocation information, for example, based on one or more rules as discussed above. Document 402, according to an embodiment, may also include a graphic 406a-c related to the product information 404a-b. The graphic 406a-b may include, but is not limited, a photograph of the product, a product label, logo, or other graphical information. A graphic 406a-c, as content information, may also be generated based on geolocation information using techniques discussed above. For an embodiment, a document 402 includes a location indicator 408 for displaying some or all of the determined geolocation information. According to an embodiment a document 402 may be configured to receive user input to change the location indicator 408 to another location. In response, a system may update the content information based on the new location by sending a request to a system for generating content information using techniques described above.

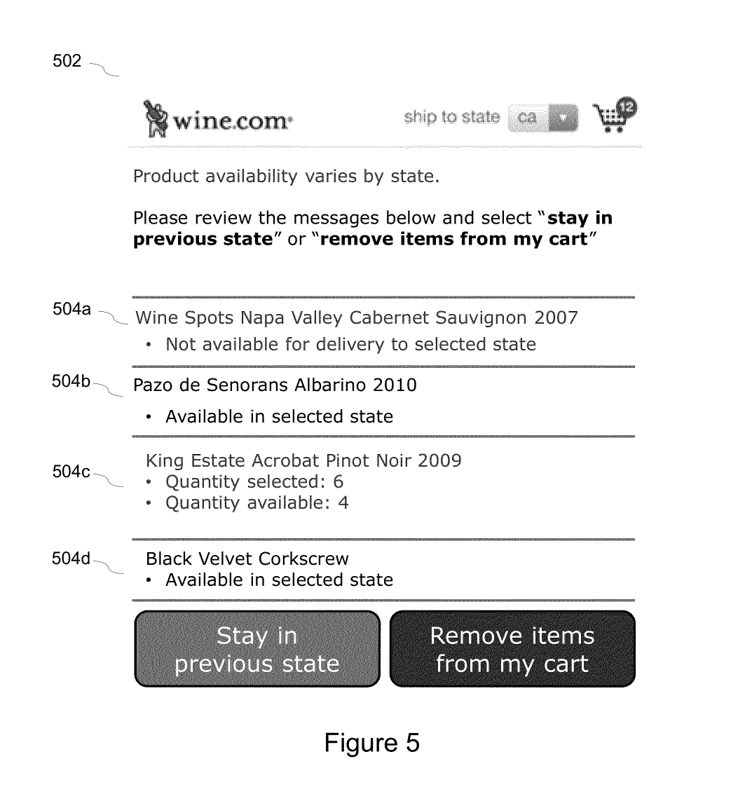

FIG. 5 illustrates another embodiment of a document 502 generated based on one or more business rules determined based on geolocation information. According to an embodiment, content information generated may include product information 504a-d based on one or more business rules determined based on geolocation information. For example, product information 504a provides availability information of a product currently in inventory based on a business rule requiring the predetermined profit margin be above a threshold for the determined location. Product information 504b may be generated, in whole or in part, based on one or more business rules that a product is available in a preferred shipping location or merchandise origin location for the determined location, according to an embodiment. Another example includes product information 504c which may be generated based on one or more business rules that provide the viewing of products that can be obtained, for example from business partners, but is not currently in inventor. In an embodiment, product information, such as product information 504d, may include information of products available regardless of determined location.

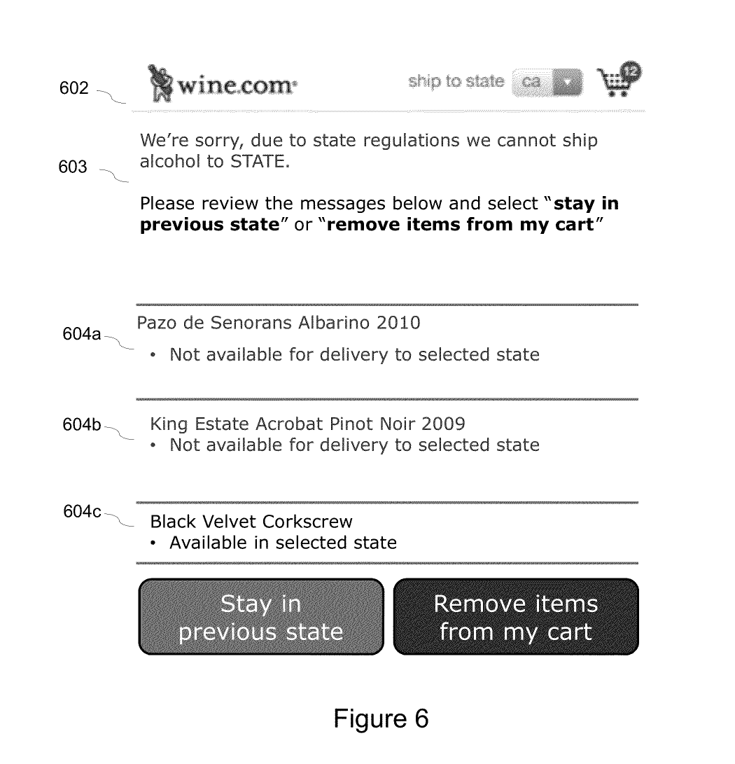

FIG. 6 illustrates an embodiment of a document 602 generated based on one or more regulations determined based on geolocation information. For an embodiment the content information generated may include general information 603 based on one or more regulations determined based on geolocation information. For example, general information 603 may inform a user about one or more regulations determined based on geolocation information, such as information that a certain product type is not available for sale because a regulation forbids the sale. According to an embodiment, content information generated may also include product information 604a-c based, in whole or in part, on one or more regulations determined based on geolocation information. For example, product information 604a and 604b may provide availability information for specific a product in inventory based on one or more regulations that do not allow the sale of the product in the determined location. Another example includes product information 504c that may include information related to products available regardless of a determined location.

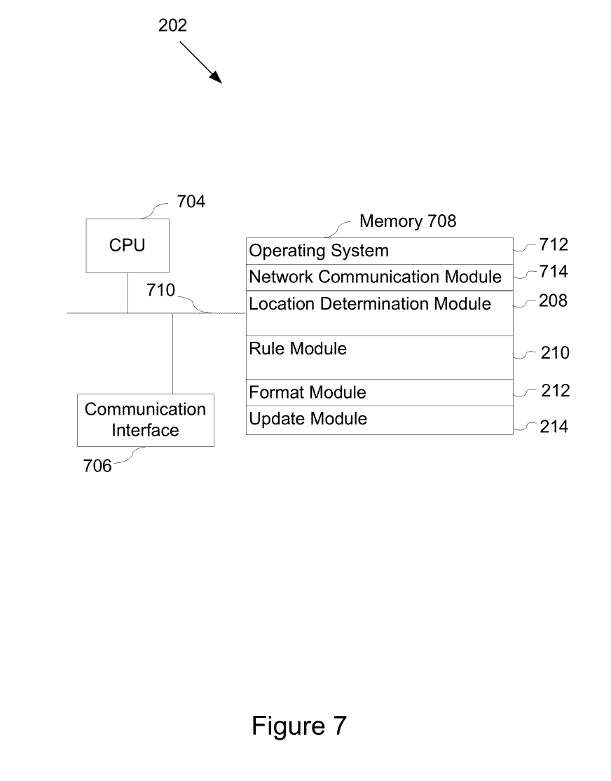

FIG. 7 illustrates an embodiment of a system 202 that implements the methods and techniques described herein that includes one or more processing units (CPUs) 704, one or more network or other communication interfaces 706, a memory 708, and one or more communication buses 710 for interconnecting these components. A system 202 may optionally include a user interface comprising a display device and a keyboard (not shown). The memory 708 may include high speed random access memory and may also include non-volatile memory, such as one or more magnetic or optical storage disks. The memory 708 may include mass storage that is remotely located from CPUs 704. Moreover, memory 708, or alternatively one or more storage devices (e.g., one or more nonvolatile storage devices) within memory 708, includes a computer readable storage medium. The memory 708 may store the following elements, or a subset or superset of such elements:

an operating system 712 that includes procedures for handling various basic system services and for performing hardware dependent tasks;

a network communication module (or instructions) 714 that is used for connecting a system 202 to other computers, clients, systems or devices via the one or more communications interfaces 706 (wired or wireless), such as the Internet, other wide area networks, local area networks, metropolitan area networks, and other type of networks;

a location determination module 208 for determining geolocation information as described herein;

a rule module 210 for determining rules based on geolocation information as described herein;

a format module 212 for transforming content information into a format for a user device as described herein; and

an update module 214 for determining the content information as described herein.

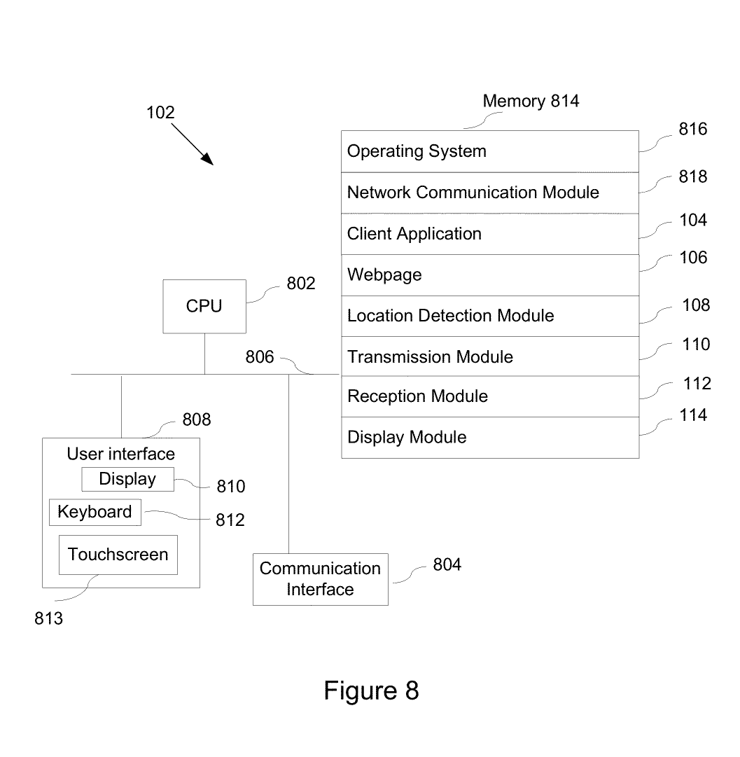

FIG. 8 illustrates an embodiment of a client or user device 102, that implements the methods described herein includes one or more processing units (CPUs) 802, one or more network or other communications interfaces 804, memory 814, and one or more communication buses 806 for interconnecting these components. The user device 102 may optionally include a user interface 808 comprising a display device 810, a keyboard 812, a touchscreen 813, and/or other input device. Memory 814 may include high speed random access memory and may also include non-volatile memory, such as one or more magnetic or optical storage disks. The memory 814 may include mass storage that is remotely located from CPUs 802. Moreover, memory 814, or alternatively one or more storage devices (e.g., one or more nonvolatile storage devices) within memory 814, includes a computer readable storage medium. The memory 806 may store the following elements, or a subset or superset of such elements:

an operating system 816 that includes procedures for handling various basic system services and for performing hardware dependent tasks;

a network communication module (or instructions) 818 that is used for connecting the user device 102 to other computers, clients, systems or devices via the one or more communications network interfaces 804 and one or more communications networks, such as the Internet, other wide area networks, local area networks, metropolitan area networks, and other type of networks; and

a client application 104 including, but not limited to, a web browser, a document viewer or other application for viewing information;

a webpage 106 as described herein;

a location detection module 108 for determining location information as described herein;

a transmission module 110 for transmitting and/or transforming location information as described herein;

a reception module 112 for receiving content information as described herein; and

a display module 114 for transforming content information into a format for viewing on a user device as described herein.

Although FIGS. 7 and 8 illustrate a client system 102 and a server system 202, the figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 7 could be implemented on a single server and single items could be implemented by one or more servers. The actual number of servers or modules used to implement server system 202 and how features are allocated among them will vary from one implementation to another, and may depend in part on the amount of data traffic that the system must handle during peak usage periods as well as during average usage periods. In addition, some modules or functions of modules illustrated in FIG. 7 may be implemented on one or more one or more servers remotely located from other servers that implement other modules or functions of modules illustrated in FIG. 7.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system for dynamically updating website content comprising:
memory;
one or more processors; and
one or more modules stored in memory and configured for execution by the one or more processors, the modules comprising:
a location detection module configured to determine location information of a user device;
a transmission module configured to transmit said location information of said user device to a server;
a reception module configured to receive content information based on said received location information from said server; and
a display module to transform said content information into a format to view on said user device.

2. The system of claim 1, wherein said content information based on said received location information includes merchandise selected based on one or more regulations corresponding to said location information.

3. The system of claim 1, wherein said content information based on said received location information includes merchandise selected based on one or more business rules corresponding to said location information.

4. The system of claim 2, wherein said one or more regulations include one or more rules related to locations where the merchandise can be shipped.

5. The system of claim 1, wherein said content information based on said received location information includes merchandise available in locations authorized to ship to a destination location corresponding to said location information.

6. The system of claim 3, wherein said one or more business rules include a required profit margin for merchandise for inclusion into said content information.

7. The system of claim 1, wherein said content information includes merchandise that can be obtained but is not currently in inventory.

8. The system of claim 1, wherein said content information includes merchandise from a preferred warehouse state.

9. The system of claim 3, wherein said one or more business rules include requiring a minimum quantity of merchandise to be purchased.

10. A retail system comprising:
memory;
one or more processors; and
one or more modules stored in memory and configured for execution by the one or more processors, the modules comprising:
a location determination module configured to request location information in response to a request for a document configured for a user device, said location determination module further configured to determine a geolocation information based on said location information;
a rule module configured to determine a set of one or more rules based on said determined geolocation information of said user device;
an update module configured to generate content information for said document based on said determined set of one or more rules; and
a transmission module configured to transmit content information generated based on said determined set of one or more rules to a user device.

11. The retail system of claim 10, wherein said set of one or more rules based on said determined geolocation location of said user device includes a set of merchandise origin locations.

12. The retail system of claim 10, wherein said set of one or more rules based on said determined geolocation information of said user device relate to alcohol regulations.

13. The retail system of claim 10, wherein said set of one or more rules based on said determined geolocation information of said user device includes one or more business rules.

14. The retail system of claim 13, wherein said one or more business rules include a required profit margin for merchandise to be included in said generated content information.

15. The retail system of claim 10, wherein said determined geolocation information includes latitudinal and longitudinal information.

16. A method for dynamically displaying information based on location information comprising:
while executing a client application on a user device;
sending a request for content information for viewing on said client application;
in response to said request for content information, receiving a request for location information;
transmitting location information in response to said request for location information;
receiving content information generated based on one or more rules that correspond to said location information; and
transforming said content information into a format for display on said user device.

17. The method of claim 16, wherein said client application is a web browser.

18. The method of claim 17, wherein transforming said content information into a format for display on said user device includes converting markup language to render the content information in a format for viewing.

19. The method of claim 16, wherein said content information is generated based on said one or more rules related to alcohol regulations for said determined location.

20. The method of claim 16, wherein said content information is generated based on said one or more rules related to one or more business rules.

21. A method for dynamically displaying information based on location information comprising:
in response to receiving a request for content information at a system, executing instructions on said system such that said system implements:
requesting location information in response to said request for content information;
in response to receiving said location information, determining geolocation information based on said location information;
determining a set of one or more rules based on said geolocation information;
generating content information based on said set of one or more rules; and
transmitting said content information generated based on said set of one or more rules.

22. The method of claim 21, wherein said set of one or more rules based on said geolocation information includes a set of merchandise origin locations.

23. The method of claim 21, wherein said set of one or more rules based on said geolocation information relate to alcohol regulations.

24. The method of claim 21, wherein said set of one or more rules based on said geolocation information includes one or more business rules.

25. The method of claim 24, wherein said one or more business rules include a required profit margin for merchandise to be included in said generated content information.

26. The method of claim 21, wherein said location information includes latitudinal and longitudinal information.
